(19) United States
(12) Patent Application Publication
(10) Pub. No.: US 2005/0211185 A1
(43) Pub. Date: Sep. 29, 2005

(54) Small animal toy with dispenser

(76) Inventors: Sally Ann Jenkins, Vancouver, WA (US); Anna Hermine Mandeville, Texarkana, TX (US)

Correspondence Address: MARGER JOHNSON & MCCOLLOM, P.C., 210 SW MORRISON STREET, SUITE 400, PORTLAND, OR, 97204, US

(21) Appl. No.: 11/023,764

(22) Filed: Dec. 27, 2004

Related U.S. Application Data
(60) Provisional application No. 60/570,974, filed on May 14, 2004.

(51) Int. Cl. A01K 15/02

(52) U.S. Cl. 119/708

(57) ABSTRACT

A toy has an attachment arm to allow the toy to attach to a pen. Attached to the attachment arm is a dispenser hold dispensable media. The toy with the dispenser may be a gym for small animals that can be suspended or set on a flat surface due to a frame structure provided.

This application claims priority from U.S. Provisional Application Ser. No. 60/570,974 filed May 14, 2004.

### BACKGROUND

Small animals, such as birds, gerbils, hamsters, etc., are often kept in small cages or pens. A wide variety of toys are generally available for these types of pets. The toys have varieties of colors, configurations and materials. They may attach to the sides of cages or hang from the tops.

The currently available toys do not have any material that the pets can remove from the toys without destroying the toy itself, other than those toys that can be preloaded with food.

### BRIEF DESCRIPTION OF THE DRAWINGS

Embodiments of the invention may be best understood by reading the disclosure with reference to the drawings, wherein:

FIG. 1 shows an embodiment of an attachment arm having a dispenser roll.

FIG. 2 shows an embodiment of an attachment arm having two dispenser rolls.

FIG. 3 shows an embodiment of an attachment arm having a dispenser roll and an angle mounting.

FIG. 4 shows an attachment arm having a crosspiece mounting.

FIGS. 5a-c show alternative views of a four-way attachment arm.

FIG. 6 shows an embodiment of a pulley toy mounted on an attachment arm.

FIG. 7 shows an embodiment of an attachment arm having a ring.

FIG. 8 shows an embodiment of a small animal gym.

### DETAILED DESCRIPTION OF THE EMBODIMENTS

FIG. 1 shows an embodiment of a small animal toy having an attachment arm, a dispenser arm and a dispenser roll. The attachment arm is formed generally by a connector or footing such as 12, which in this embodiment is a wing nut and a washer that allow the arm to be attached to the wires of an animal pen, such as a birdcage. A pin or other element forms an axis 24 of the attachment arm 10. In this embodiment, the attachment arm 10 is the same as the dispenser arm to which the dispenser roll 22 is attached.

The connector or footing such as the wing nut 12 allow the toy to be mounted to a cage, either on the side or on the top, hang from a ceiling or other framing mount, or rest on a table top or other surface. As will be discussed further, the connector or footing provides the structural support for the toy assembly. The term ‘mounting’ as used here includes a connector that allows the toy to be attached to a structure, or a footing that allows it to stand freely.

Various components for entertaining the animal may be arranged along the attachment arm or the dispenser arm, or both. Caps 14a and 14b form the ends of the attachment arm, with an eyehook 18 forming a ring from which various toys or other components may be suspended, such as the chain link 20. As will be discussed in further embodiments, many different elements may be suspended from the arms. Suspension of the component may occur if the attachment arm is attached to the side, top or bottom of the cage. No limitation of any particular mounting orientation is intended.

In the embodiment of FIG. 1, a dispenser roll 22 allows the animal to pull on some sort of dispensable media, such as paper from the roll. The animal is then free to tear the media, separating from the roll, or just continue to pull it until it is all dispensed. An example of such a dispenser and dispensable media could be a roll of accounting machine tape. The media can be played with while attached to the roll, or removed from the roll and played with.

The dispensable media could be any kind of non-harmful media, such as ribbon, string, rope, etc. It would be desirable that if the animal could peck or bite pieces of the media off from the roll, that it not hurt the animal if consumed. For this reason, it may be preferable to use paper. In practice, rolls of accounting tape seemed to provide much interaction and activity for small animals, especially birds.

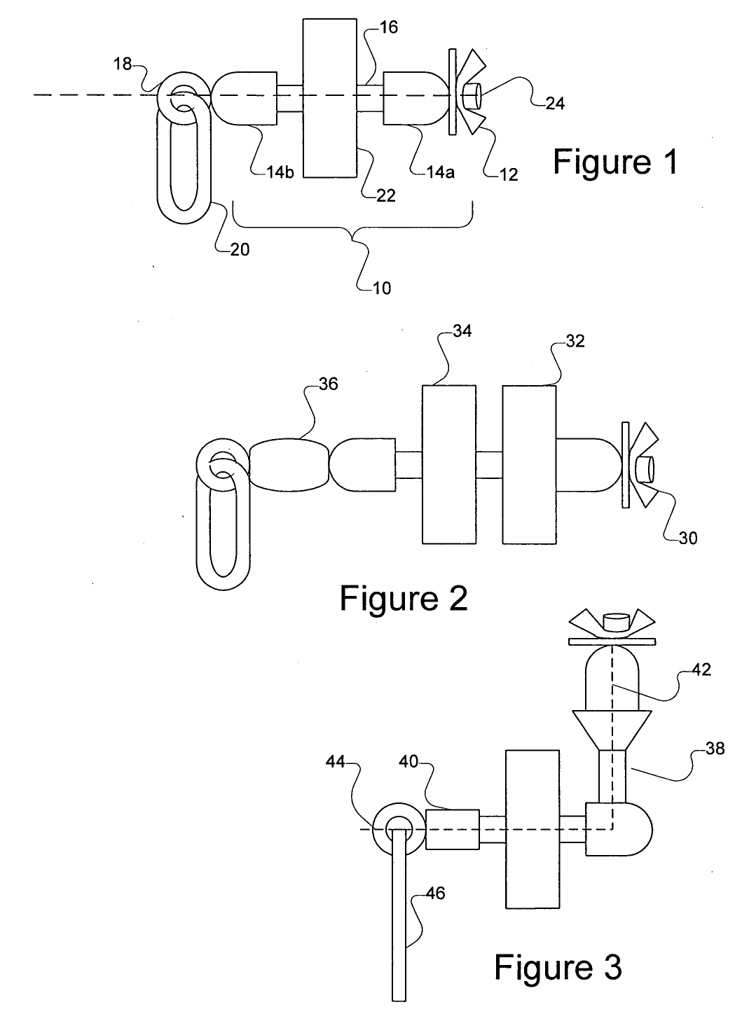

As shown in FIG. 2, it is possible to mount more than one dispenser of dispensable media, such as rolls 32 and 34 to the attachment arm that is connectable by connector 30. In addition, FIG. 2 demonstrates more of the many possible components, having a curved bead 36. All of the components may be of different colors, lending visual variety to the toy as well.

FIGS. 1 and 2 show a combined attachment arm and a dispenser arm. FIG. 3 shows an attachment arm and a separate dispenser arm. The axis 42 is for the attachment arm, and axis 44 is for the dispenser arm. Toys may be attached to either arm, and there may actually be a dispenser on the attachment arm. The toy could be mounted from the top, bottom or sides of the pen, from a ceiling or other structure, as well as free-standing on a table top or other surface. In addition, FIG. 3 shows more components, including cylindrical bead 40, tapering bead 38 and a ring 46, shown in the side view.

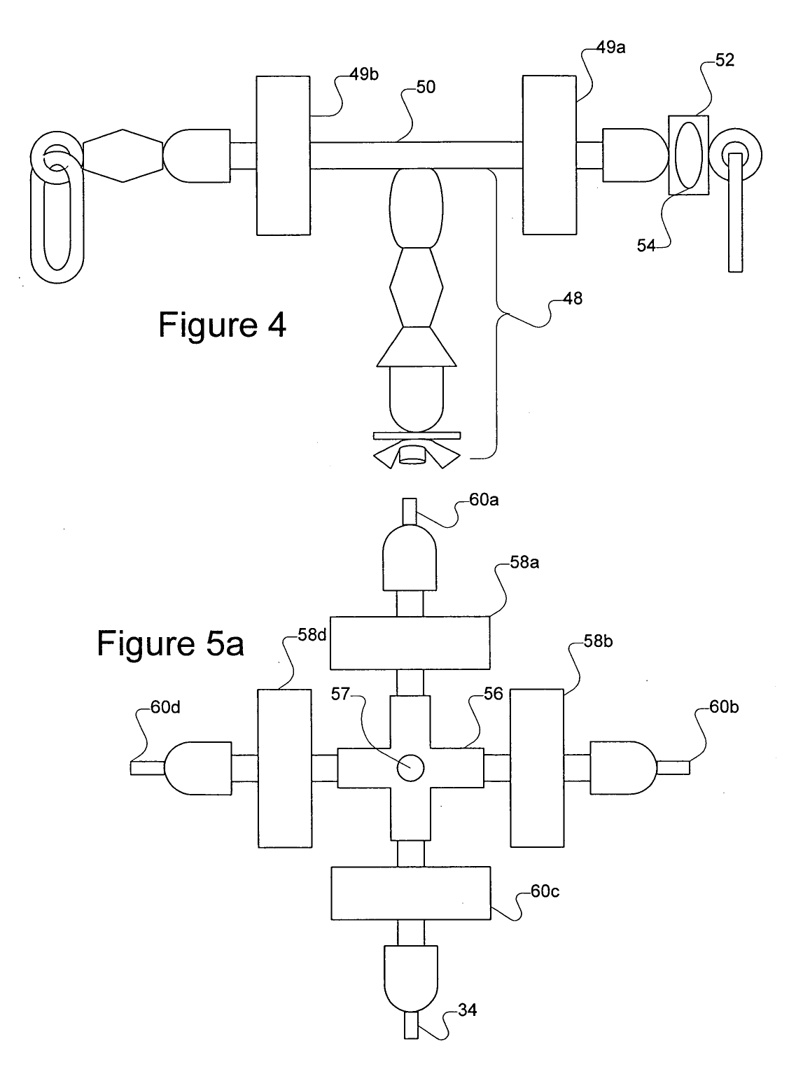

FIG. 4 shows yet another alternative arrangement of dispensers. The attachment arm 48 is connected to a cross piece 50, upon which there are two dispensers 49a and 49b. FIG. 4 also shows a new component 52 that is a piece having an access hole 54. Snacks, such as nuts and seeds, may be inserted into the access hole, providing the animal with entertainment as it discovers, removes and eats the snacks.

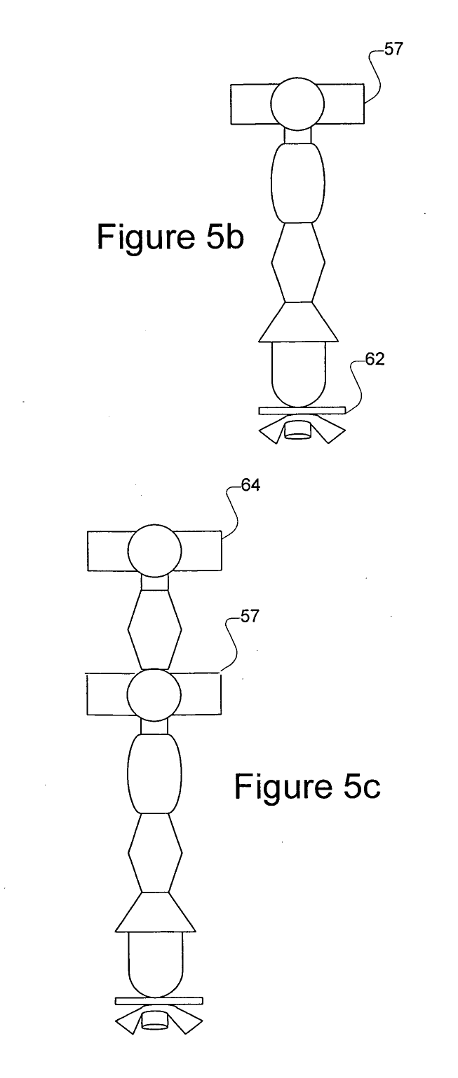

In addition to an angled mounting, it is possible to have several dispenser arms mounted to a centerpiece attachment arm. As can be seen in FIG. 5a, a centerpiece 57 is attached to the attachment arm through the pin 56. Pin 56 extends behind the toy along the axis through the page, as will become apparent in other views. Each arm of the toy radiating from the centerpiece 57 could have a dispenser 58a-d and an eyehook 60a-d. Each eyehook could have a different component, such as chain links, rings, beads, etc., suspended from them. Each arm could also be of different lengths with different shapes or colors of the beads.

FIG. 5b shows a side view of the attachment arm centerpiece 57. The other components have been removed for ease of viewing. The centerpiece 57 can be attached to the cage by the top, side or bottom of the cage or pen, as well as stand freely on a surface. As the connector 62 is fixed, it is possible that the pin 56 can be selected so as to allow the centerpiece to spin. This movement affords even more stimulation and entertainment to the animal.

For even more stimulation, two center piece attachment arms, 57 and 64 could be mounted on the attachment arm, as shown in FIG. 5c. Each centerpiece could rotate independently of the other, or one could be fixed and the other rotates. The pin used to connect the centerpiece may be selected to allow the centerpiece to rotate or not. Pin, as that term is used here, is any means used to connect the centerpiece to the other components forming the dispenser arms of the toy. When the pin selected allows the centerpiece to rotate, it will be referred to as a spinning mounting or a spinning dispenser arm.

Spin mounting is not limited to just the centerpieces shown in FIGS. 5a-c. The cross piece 50 of FIG. 4 may rotate as well. The connection between the two axes of FIG. 3 may allow the arm formed along axis 44 to rotate about the axis 42.

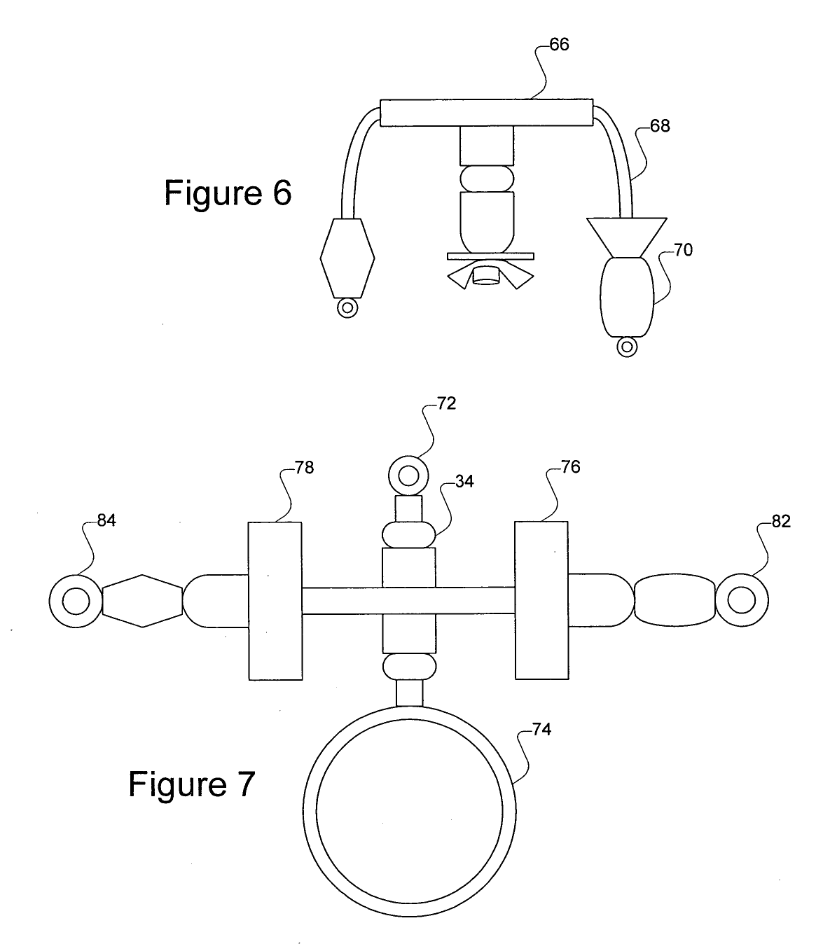

Another alternative to the cross piece such, as 50 of FIG. 4 could be to have a hollow cylinder cross piece that forms a sleeve for a pulley toy. An example is shown in FIG. 6. The attachment arm supports the cross piece 66, which is hollow, similar to the cross piece of FIG. 4. However, in FIG. 4, the center of the crosspiece held the hardware component upon which the various components were mounted.

In FIG. 6, the cross piece has a piece of rope, chain or other material 68 that has been inserted into the sleeve. Toys of some kind reside at either end. The animal can then pull on the toy, such as bead 70 and actually cause the toy to move. Another option for the bead 70 would be to use wood blocks at which the animal could peck or gnaw. As the sleeve 66 is mounted at the end of the attachment arm, the pulley toy is operable if mounted to the top, bottom or sides of the pen, or could be freestanding.

An alternative mounting for a toy is shown in FIG. 7. Instead of a connector for mounting the arm to the wires of the cage or pen, a ring 72 is provided to allow the toy to be suspended from the top. The attachment arm supports a cross piece 80 and a ring 74. The animal could perch on either the cross piece or the ring. As the cross piece dispenser arm 80 is not connected as directly to the cage, this may provide the animal with the opportunity to swing the entire toy while perched upon it. Dispensers 76 and 78 may be included, as could many other components. Rings 82 and 84 could support more rings such as 74, forming an ‘animal gym.’

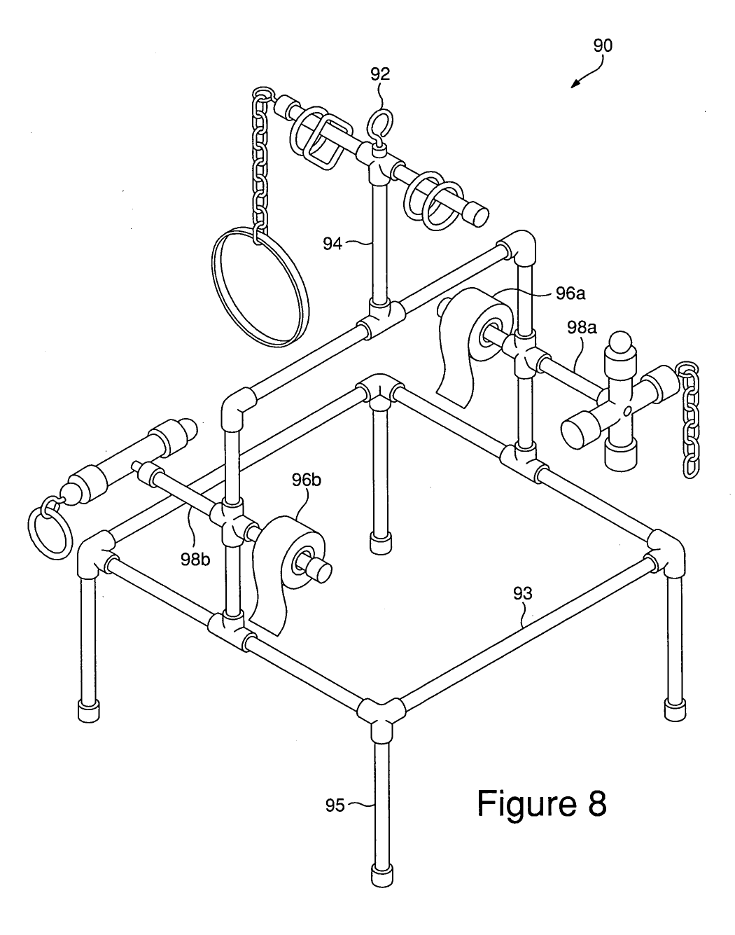

FIG. 8 description here.

In either animal gym, the dispensers, pulley toys, beads, beads with access holes, chain links, rings, etc., can all be mounted as desired to entertain the animal. The only limitation to the selection and positioning of all of the various components is the animal owner or caretaker's imagination and available components.

Thus, although there has been described to this point a particular embodiment for a small animal toy, it is not intended that such specific references be considered as limitations upon the scope of this invention except in-so-far as set forth in the following claims.

1. A toy, comprising:
an attachment arm to support the toy;
a dispenser arm connected to the attachment arm; and
a dispenser attached to the dispenser arm to hold dispensable media.

2. The toy of claim 1, the toy comprising a second dispenser attached to the dispenser arm.

3. The toy of claim 1, the toy comprising a second dispenser arm and a second dispenser attached to the second dispenser arm.

4. The toy of claim 3, the first and second dispenser arms being arranged perpendicular to each other.

5. The toy of claim 3, the first and second dispenser arms having two dispensers each, arranged at either end.

6. The toy of claim 1, the toy comprising a sleeve attached to one of either the attachment arm or the dispenser arm, the sleeve to hold a pulley toy.

7. The toy of claim 1, the toy comprising a container having an access hole attached to one of either the attachment arm or the dispenser arm.

8. The toy of claim 1, the toy comprising a wood block attached to one of either the attachment arm or the dispenser arm.

9. The toy of claim 1, the attachment arm further comprising a side-mount attachment arm.

10. The toy of claim 1, the attachment arm further comprising a top-bottom mount attachment arm.

11. The toy of claim 1, the toy further comprising a spinning dispenser arm.

12. The toy of claim 1, the dispenser further comprising a paper roll dispenser.

13. The toy of claim 1, the attachment arm and the dispenser arm being the same arm.

14. An animal gym, comprising:
a mounting;
at least one dispenser roll to dispense consumable media; and
at least one spinner.

15. The gym of claim 14, the mounting further comprising a top mount.

16. The gym of claim 15, the top mount further comprising hook to allow the gym to be suspended.

17. The gym of claim 14, the mounting further comprising a surface frame to allow the gym to be set up upon a flat surface.

18. The gym of claim 14, the gym further comprising a sleeve holding a pulley toy.

19. The gym of claim 14, the gym further comprising a container having an access hole.

20. The gym of claim 14, the gym further comprising at least one block of wood.

21. The gym of claim 14, the gym further comprising at least two support arms, each support arm having at least one dispenser roll.

22. The gym of claim 14, the gym further comprising at least one ring.
